(19) United States
(12) Patent Application Publication
(10) Pub. No.: US 2008/0160814 A1
(43) Pub. Date: Jul. 3, 2008

(54) Land grid array connector assembly with pick up cap

(75) Inventor: David Gregory Howell, Gilbert, AZ (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/648,001

(22) Filed: Dec. 28, 2006

(51) Int. Cl. H01R 13/62

(52) U.S. Cl. 439/331

(57) ABSTRACT

An LGA connector assembly (1) includes an LGA connector (2) and a pick up cap (3). The connector includes a stiffener (23), an insulative housing (21) arranged in the stiffener, a plurality of contacts (22) received in the housing, a retention structure (4) having a metal clip (25) and a substantially rectangular lever (24). The housing defines a cavity (210) for receiving an LGA central processing unit (CPU) therein. The metal clip and the lever are pivotably respectively received in opposite ends of the stiffener. The pick up cap is generally rectangular, and has at least one clasp (302) at each side thereof. The clasp engages with the lever of the connector to securely mount the pick up cap onto the connector. The pick up cap has a flat top surface (300) to be engaged by a vacuum suction device, The LGA connector assembly thus can be moved to a desire location on a printed circuit board (PCB).

### BACKGROUND OF THE INVENTION

1. Field of the Invention

The present invention relates to a land grid (LGA) connector assembly which comprises an LGA connector and a pick up cap, the pick up cap being mounted to the connector for providing a flat top surface to be engaged by a vacuum suction device, whereby the LGA connector assembly can be moved onto a circuit substrate such as a printed circuit board (PCB) on which the connector is to be mounted.

2. Description of the Prior Art

Using vacuum suction to support and transfer an electrical connector is well known in the electronics field. Such an LGA connector typically comprises an insulative housing, a plurality of electrical contacts received in the housing, a metal clip pivotably mounted to an end of the housing, and a lever pivotably mounted to opposite end of the housing for engaging with the clip. The clip has a generally rectangular window in a middle thereof. Each contact has a first contact portion protruding outwardly from a top portion of the housing, for electrically connecting with a multiplicity of metal contact pads of an LGA central processing unit (CPU) respectively. Thus, a pick up cap has to be pre-attached on the top portion of the housing. The pick up cap typically has a plurality of latches snapping corresponding sidewalls of the housing, thereby mounting the pick up cap onto the LGA connector. The pick up cap has a smooth flat top surface exposing from the window. The vacuum suction device is then able to engage on the flat top surface of the pick up cap, in order to reliably move and accurately position the LGA connector onto the PCB.

However, a problem exerts with this kind of the pick up cap. During attaching of the pick up cap onto the LGA connector or detaching the pick up cap from the LGA connector, the latches of the pick up cap are liable to hit the first contact portions of some of the contacts, which transfer the contacts from desired positions of the contacts. Thus, the contacts being hit cannot electrically contact the corresponding metal contact pads of the CPU, and the electrical connection between the CPU with the PCB cannot be established.

Therefore, a new pick up cap that overcome above-mentioned disadvantages is desired.

### SUMMARY OF THE INVENTION

Accordingly, an object of the present invention is provision of a land grid array (LGA) connector assembly which has an LGA connector and a pick up cap mounted on the connector, wherein the pick up cap has minimal risk of damaging contacts of the connector during attaching the pick up cap onto the connector or detaching the pick up cap from the connector.

To fulfill the above-mentioned objects, an LGA electrical connector assembly accordance with a preferred embodiment comprises an LGA connector and a pick up cap. The connector includes a stiffener, an insulative housing arranged in the stiffener, a plurality of contacts received in the housing, and a retention structure having a metal clip and a substantially rectangular lever. The housing defines a cavity for receiving an LGA central processing unit (CPU) therein. The metal clip and the lever are pivotably respectively received in opposite ends of the stiffener. The pick up cap is generally rectangular, and has at least one clasp at each side thereof. The clasp engages with the lever of the connector to securely mount the pick up cap onto the connector. The pick up cap has a flat top surface to be engaged by a vacuum suction device, The LGA connector assembly thus can be moved to a desire location on a printed circuit board (PCB).

Other objects, advantages and novel features of the present invention will become more apparent from the following detailed description when taken in conjunction with the accompanying drawings.

### BRIEF DESCRIPTION OF THE DRAWINGS

FIG. 1 is an exploded, isometric view of an LGA electrical connector assembly of the present invention which comprising an electrical connector and a pick up cap mounted onto the electrical connector;

FIG. 2 is an assembled view of an LGA connector of FIG. 1; and

FIG. 3 is an assembled view of an LGA connector and a pick up cap of FIG. 1.

### DESCRIPTION OF PREFERRED EMBODIMENT OF THE INVENTION

Reference will now be made to the drawings to describe the present invention in detail.

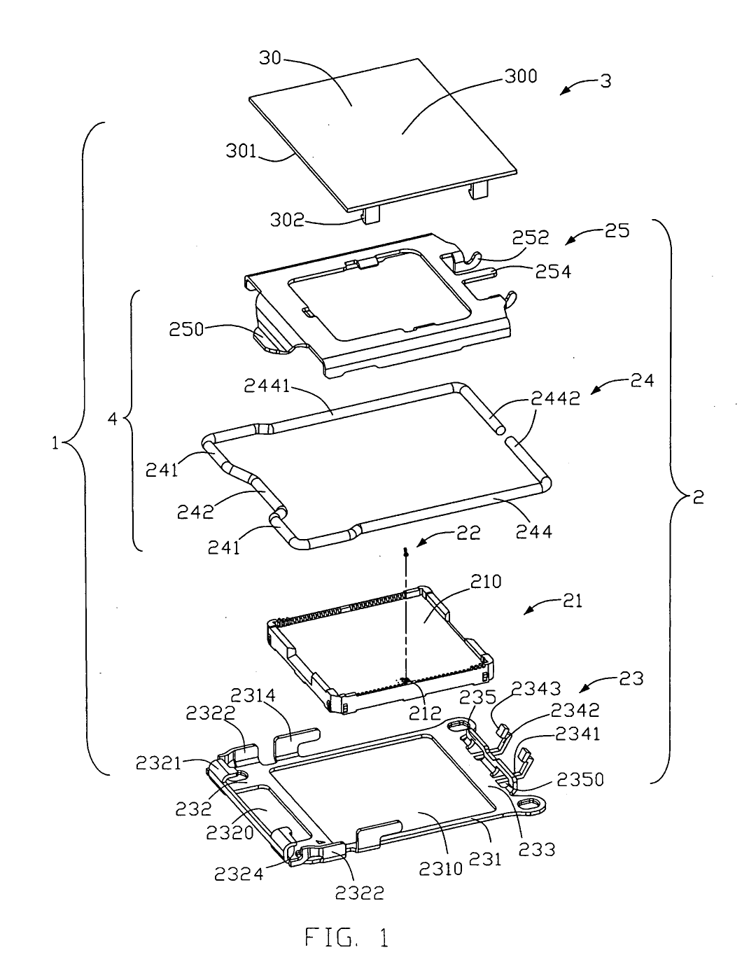

FIG. 1 shows an exploded, isometric view of a land grid array (LGA) connector assembly 1 in accordance with a preferred embodiment of the present invention. The LGA connector assembly 1 comprises an LGA connector 2 and a generally rectangular pick up cap 3. The pick up cap 3 is mounted onto the connector 2 for provision of a flat top surface facilitating to be sucked by a vacuum suction device, thereby manipulating the LGA connector assembly 1 onto a substrate circuit, such as a printed circuit board (PCB) (not shown), where the connector 2 is seated.

The connector 2 comprises a generally rectangular insulative housing 21, a plurality of electrical contacts 22 received in the housing 21, a metal stiffener 23 containing the housing 21 to enforce the housing 21, a retention structure 4 having a substantially rectangular lever 24 and a metal clip 25. The lever 24 is pivotably received in an end of the stiffener 23, and the metal clip 25 is pivotably mounted to an opposite end of the stiffener 23 for engaging with the lever 24.

The housing 21 defines a generally rectangular cavity 210 in a middle thereof. The cavity 210 is used for receiving an electronic package such as an LGA central processing unit (CPU) (not shown) therein. A multiplicity of passageways 212 is defined in a portion of the housing 21 under the cavity 210, the passageways 212 receiving a corresponding number of the contacts 22 therein respectively. Each contact 22 has a first contact portion (not labeled) protruding outwardly from a top face of the housing 21, for resiliently electrically contacting the CPU.

The stiffener 23 comprises a head portion 232, a rear portion 233 and a middle portion 231 defining a rectangular cavity 2310 and connecting the head portion 232 and the rear portion 233. The head portion 232 comprises a pair of U-shaped resistant arm 2321 formed at a front end and each resistant arm 2321 defining a chamber 2324 thereunder, a pair of L-shaped resilience tab 2322 formed at both opposite sides thereof, and a rectangular slot 2320 defined between the resistant arms 2323. The middle portion 231 forms a pair of L-shaped metal ears 2314 at both sides thereof. The rear portion 233 comprises a rear wall 235 defining a pair of spaced slots 2350 thereof. A pair of retaining arm 234 is formed at a rear end of the rear portion 233 and each retaining arm 234 has a base portion 2341 extending beyond the rear wall 235 and a connecting portion 2342 extending upwardly and obliquely from the base portion 2341. A retaining key 2343 is formed at a top end of the connecting portion 2342 of the retaining arm 234.

The lever 24 comprises a pair of locating portion 241 pivotably received in the chamber 2324 of the resistant arm 2321 of the stiffener 23, an actuating portion 242 between the locating portions 240, and a pair of L-shaped operating portions 244 each having an abutting portion 2441 extending rearwardly from an end of the locating portions 241 and a pressing portion 2442 perpendicular to the abutting portion 2441. The operating portion 244 is disposed at an outside of the stiffener 23 and engages with the retaining arm 234 when the lever 24 is at a closing position.

The metal clip 25 comprises an engaging portion 250 extending arcuately from an end thereof, a pair of spaced securing portions 252 extending arcuately from an opposite end thereof corresponding to the slots 2350 of the stiffener 23, and a tail 254 between the securing portions 252. The securing portions 252 are pivotably received in the slots 2350 of the stiffener 23. When the clip 25 is oriented at a horizontal position parallel to the top face of the housing 21, the engaging portion 250 of the clip 25 engages with the actuating portion 242 of the lever 24 for pressing the CPU on the contacts 22. When the clip 25 is oriented at a position perpendicular to the top face of the housing 21, the tail 254 abuts against the stiffener 23 to prevent the clip 25 from being over-rotated.

The pick up cap 3 has a generally rectangular planar body 30. The planar body 30 comprises a smooth flat top surface 300 and a bottom surface 301 opposite to the top surface 300. A pair of clasps 302 is formed at each side of the pick up cap 3 for securing the pick up cap 3 and LGA connector assembly 1.

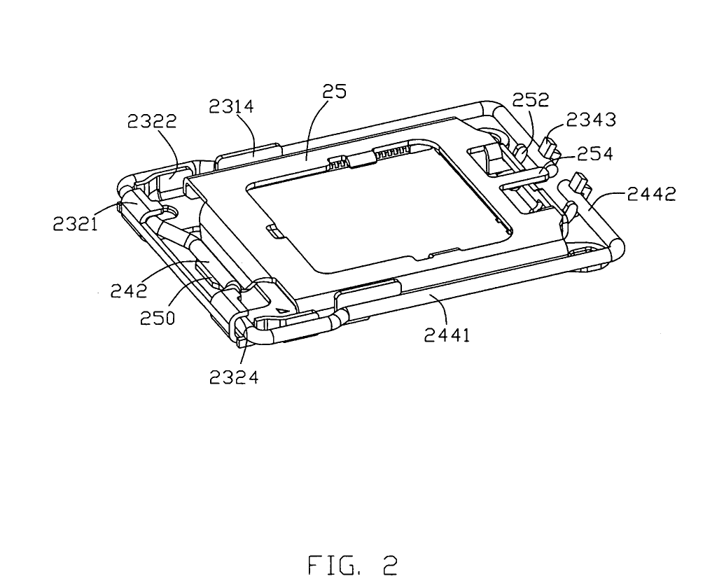

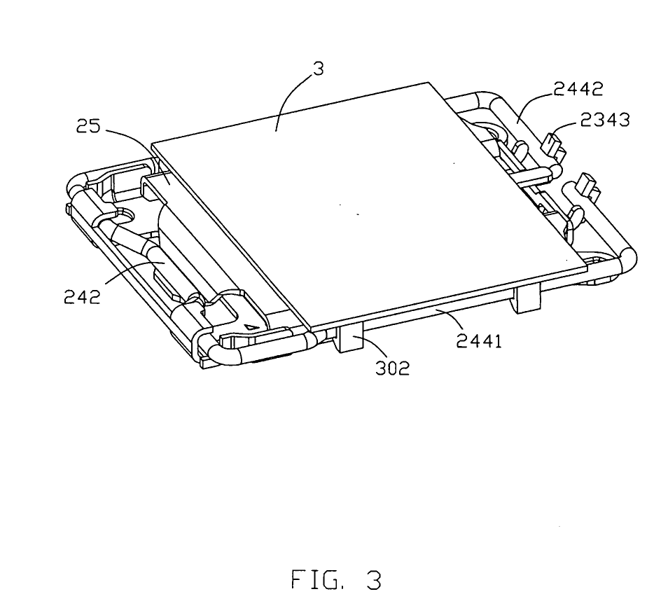

Referring to FIGS. 2-4, in assembly process, the contacts 22 are pre-loaded within the insulative housing 21. The insulative housing 21 is then received in the stiffener 23. The locating portions 241 of the lever 24 are pivotably received in the chambers 2324 of resistant arms 2321 of the stiffener 23. The securing portions 252 are pivotably received in the slot 2350 of the stiffener 23. When the metal clip 25 is at a closing position, the engaging portion 250 of the metal clip 25 is arranged above the rectangular slot 2323 of the front portion 232. The pressing portion 2442 of the operating portion 244 is pressed down and engages with the retaining key 2341 of the retaining arm 234, and the actuating portion 242 of the lever 24 presses the engaging portion 250 of the metal clip 25. Each the abutting portion 2441 of the operating portions 244 surrounds each side of the stiffener 23, and abuts against the resilience tab 2322 and the metal ear 2314 of the stiffener 23. Finally, the pick up cap 3 is mounted on the lever 24 by the clasps 302 interference engaging the abutting portion 2441 of the lever 24, thereby securely mounting the pick up cap 3 onto the connector 2. A vacuum suction device (not shown) can suck the top surface 300 of the pick up cap 3 in order to move the connector assembly 1 to a desired location on the PCB.

As appreciable from the foregoing description, the pick up cap 3 of the LGA connector assembly 1 snaps the abutting portion 2441 of the lever 24 of the connector 2, but not snaps sidewalls of the housing 21. Thus, during attaching the pick up cap 3 onto the connector 2 or detaching the pick up cap 3 onto the connector 2, the clasps 302 of the pick up cap are unlikely to hit the first contact portions of the contacts 22.

Although the present invention has been described with reference to a particular embodiment, it is not to be construed as being limited thereto. Various alterations and modifications can be made to the embodiment without in any way departing from the scope or spirit of the present invention as defined in the appended claims

1. A land grid array (LGA) connector assembly, comprising:
a stiffener;
a metal clip defining a central opening and a lever pivotably respectively received in opposite ends of the stiffener;
an insulative housing arranged in the stiffener, the housing defining a substantially rectangular cavity in a middle thereof, the cavity being adapted for receiving an electronic package therein;
a plurality of electrical contacts received in a portion of the housing under the cavity; and
a pick up cap, with thereon sufficient planar upper area for suction, interengaged to the lever to cover the central opening of the metal clip and also partially covers the lever, the pick up cap is associated moved along with the lever when the lever is rotated about the a stiffener.

2. The LGA connector assembly as claimed in claim 1, wherein the pick up cap has at least one clasp at each side for interengaging with the lever.

3. The LGA connector assembly as claimed in claim 2, wherein the lever is a substantially rectangular structure and has a pair of locating portion, an actuating portion formed between the locating portion, a pair of L-shaped operating portions each connecting the locating portion respectively.

4. The LGA connector assembly as claimed in claim 3, wherein each the operating portion comprises an abutting portion and a pressing portion perpendicular to the abutting portion.

5. The LGA connector assembly as claimed in claim 4, wherein the stiffener has a pair of resistant arm at a front end, a pair of L-shaped metal ears at both sides, a pair of spaced slots defined at a rear end and a pair of retaining arm extending beyond the rear end.

6. The LGA connector assembly as claimed in claim 5, wherein each the retaining ann has a base portion extending beyond the rear end and a connecting portion extending upwardly and obliquely from the base portion.

7. The LGA connector assembly as claimed in claim 6, wherein a retaining key is formed at a top end of the connecting portion of the retaining ann for engaging with the pressing portion of the operating portion of the lever.

8. (canceled)

9. (canceled)

10. (canceled)

11. (canceled)

12. (canceled)

13. (canceled)

14. (canceled)

15. (canceled)

16. (canceled)

17. The assembly as claimed in claim 19, wherein said pick up cap is engaged to the lever, seated upon the clip and covering the cavity.

18. (canceled)

19. A land grid array (LGA) connector assembly, comprising:
a metal clip and a lever pivotably respectively mounted to the stiffener;
an insulative housing arranged in the stiffener, the housing defining a cavity in a middle thereof, the cavity being adapted for receiving an electronic package therein; and
a plurality of electrical contacts received in the housing under the cavity; wherein
said leer extends along the periphery of said stiffener by at least three sides of the stiffener;
further including a pick up cap providing a planar sufficient upper area for suction and substantially covering the metal clip; wherein
said pick up cap is associatively moved along with the lever when the lever is rotated about the stiffener.

20. (canceled)

21. A land grid array (LGA) connector assembly, comprising:
a stiffener having a first end and a second end, and with an anchoring device disposed on the first end;
an insulative housing arranged in the stiffener, the housing defining a substantially rectangular cavity in a middle thereof, the cavity being adapted for receiving an electronic package therein;
a plurality of electrical contacts received in a portion of the housing under the cavity;
a metal clip rotationally assembled to the first end of the stiffener to rotate from an open position to a closed position for pressing a CPU toward the contact of the housing and including a tab substantially extending to the second end of the stiffener;
a lever including a shaft rotationally assembled to the second end of the stiffener, and including a cam portion capable of pressing the tab of the clip toward the stiffener when the clip is located in the closed position, and including a first arm extending substantially perpendicular from a first end of the shaft, and a second arm extending substantially perpendicular from a second end of the shaft to rotate the cam from a first position in which the tab of the clip is free to engage, and a second position in which the tab is pressed, and each of the first and second arm interlocked with the anchor when the cam is located at the second position; and
a pick up cap attached to the first and second arms of the lever.

22. The LGA connector assembly as claimed in claim 21, wherein a pick up cap is engaged to the lever, seated upon the clip and covering the cavity.

23. The LGA connector assembly as claimed in claim 22, wherein the pick up cap has at least one clasp at each side for interengaging with the lever.

24. The LGA connector assembly as claimed in claim 23, wherein said pick up cap is associatively moved along with the lever when the lever is rotated about the stiffener.

25. The LGA connector assembly as claimed in claim 21, wherein the stiffener has a pair of resistant arm at a second end, a pair of L-shaped metal ears at both sides, a pair of spaced slots defined at a first end and an archoring device extending beyond the first end.

26. The LGA connector assembly as claimed in claim 25, wherein the archoring device has a base portion extending beyond the first end and a connecting portion extending upwardly and obliquely from the base portion.

27. The LGA connector assembly as claimed in claim 26, wherein a retaining key is formed at a top end of the connecting portion of the archoring device for engaging with the first and second arm of the lever.

28. The LGA connector assembly as claimed in claim 19, wherein the stiffener defines a retaining key defining an upward space on an inner side thereof so as to allow the lever to be downwardly moved into said space to push said retaining key outwardly, and said retaining key successively resumes to an original position for locking said lever in position.

29. The LGA connector assembly as claimed in claim 28, wherein said clip defines a securing portion for holding the clip to the stiffener, and said securing portion cooperates with the retaining key to define a gap into which said lever is retained.

30. The LGA connector assembly as claimed in claim 28, wherein said clip defines a tab corresponding to the retaining key and further cooperates with the retaining key to define a gap into which said lever is retained.

31. The LGA connector assembly as claim 30, wherein a free distal end of said lever is retained in said gap.
